(19) United States
(12) Patent Application Publication
(10) Pub. No.: US 2026/0249968 A1
(43) Pub. Date: Aug. 27, 2026

(54) DRIVE MECHANISM AND TILT-TRIM DEVICE

(71) Applicant: Astemo, Ltd., Tokyo (JP)

(72) Inventors: Hayato TSUTSUI, Hitachinaka-shi (JP); Kohei SUNAMI, Hitachinaka-shi (JP); Naoya TAGA, Hitachinaka-shi (JP)

(73) Assignee: Astemo, Ltd., Tokyo (JP)

(21) Appl. No.: 19/546,082

(22) Filed: Feb. 20, 2026

(30) Foreign Application Priority Data
Feb. 21, 2025 (JP) 2025-026592

(51) Int. Cl. B63H 20/10; F15B 1/26; F15B 13/04; F15B 15/14

(52) U.S. Cl. CPC B63H 20/10; F15B 1/26; F15B 13/0401; F15B 15/1447; F15B 2211/20576

(57) ABSTRACT

A drive mechanism has a tank which stores a hydraulic fluid, a cylinder, and a pump which feeds the hydraulic fluid from the tank to the cylinder. The cylinder includes a cylinder, a piston, and the piston rod. The pump includes a first pump which discharges the hydraulic fluid from a first discharge portion by rotating in a first direction and discharges the hydraulic fluid from a second discharge portion by rotating in a second direction, a second pump which discharges the hydraulic fluid from a third discharge portion by rotating in the first direction and discharges the hydraulic fluid from a fourth discharge portion by rotating in the second direction, an intake path, first to fourth flow paths, a branch path which branches from the second flow path to reach the tank or the intake path, and an on-off valve which opens the second branch path.

### CROSS-REFERENCE TO RELATED APPLICATIONS

This application is based on and claims the benefit of priority under 35 USC §119(b) to Japanese Patent Application No. 2025-026592 filed on Feb. 21, 2025, the entire content of which is incorporated herein by reference.

### FIELD OF THE INVENTION

The present disclosure relates to a drive mechanism and a tilt-trim device.

### BACKGROUND OF THE INVENTION

For example, a ship is provided with a tilt-trim device that adjusts an inclination angle of a hull with respect to an outboard engine. The tilt-trim device includes a drive mechanism including a piston rod. The inclination angle of the hull can be adjusted by advancing and retracting the piston rod. JP6449641B discloses a technique in the related art of the tilt-trim device.

A drive mechanism of the tilt-trim device as disclosed in JP6449641B includes a first pump and a second pump for feeding oil, a cylinder to which the oil is fed by these pumps, and the piston rod having one end accommodated in the cylinder and the other end protruding from the cylinder. A swivel case swings by advancing and retracting the piston rod, and the inclination angle of the hull can be adjusted.

The oil fed by the pumps flows through a flow path connected to the cylinder. The flow path is provided with a plurality of valves. These valves can release the oil to the tank by opening a part of the flow path when a hydraulic pressure in the cylinder is excessive or when a hydraulic pressure in the flow path is excessive. The oil in the tank is sucked up by the pump and circulates in the flow path.

According to the tilt-trim device disclosed in JP6449641B, many valves are provided to appropriately manage a pressure of a hydraulic fluid. It is required to improve the above from a viewpoint of reducing the number of components.

### SUMMARY OF INVENTION

An object of the present disclosure is to provide a drive mechanism including a small number of components, and a tilt-trim device equipped with the drive mechanism.

A first aspect of the present disclosure is a drive mechanism having:

a tank configured to store a hydraulic fluid;

a cylinder unit in which a piston rod advances and retreats due to the hydraulic fluid fed from the tank; and

a pump unit configured to feed the hydraulic fluid from the tank to the cylinder unit, in which

the cylinder unit includes:

a cylinder having a cylindrical shape;

a piston that partitions an inside of the cylinder into two chambers including a first chamber and a second chamber; and

the piston rod having one end fixed to the piston and another end protruding outside the cylinder,

a protruding amount of the piston rod from the cylinder decreases by feeding the hydraulic fluid to the first chamber, and the protruding amount of the piston rod from the cylinder increases by feeding the hydraulic fluid to the second chamber, and

the pump unit includes:

a first pump configured to discharge the hydraulic fluid from a first discharge portion by rotating in a first direction, and configured to discharge the hydraulic fluid from a second discharge portion by rotating in a second direction opposite to the first direction;

a second pump different from the first pump, operating in conjunction with an operation of the first pump, configured to discharge the hydraulic fluid from a third discharge portion by rotating in the first direction, and configured to discharge the hydraulic fluid from a fourth discharge portion by rotating in the second direction;

an intake path through which the hydraulic fluid is sucked to feed into the first pump or the second pump;

a first flow path connecting the first chamber to the first discharge portion, and through which the hydraulic fluid flows;

a second flow path connecting the second chamber to the second discharge portion, and through which the hydraulic fluid flows;

a third flow path connecting the first chamber to the third discharge portion, and through which the hydraulic fluid flows;

a fourth flow path connecting the second chamber to the fourth discharge portion, and through which the hydraulic fluid flows;

a second branch path branching from the second flow path to reach at least one of the tank or the intake path; and

a second on-off valve provided in the second branch path, and configured to open the second branch path in a case where a pressure in the first chamber is higher than a predetermined pressure when the first pump rotates in the second direction or in a case where a pressure in the second flow path is higher than a predetermined pressure when the first pump rotates in the first direction.

A second aspect of the present disclosure is a tilt-trim device provided on a hull to adjust an inclination angle of the hull with respect to an outboard engine, the tilt-trim device having:

the drive mechanism according to claim 1, in which

the inclination angle of the hull with respect to the outboard engine is increased by supplying the hydraulic fluid to the second chamber, and

the inclination angle of the hull with respect to the outboard engine is decreased by supplying the hydraulic fluid to the first chamber.

According to the aspects of the present disclosure, it is possible to provide the drive mechanism including a small number of components, and the tilt-trim device equipped with the drive mechanism.

### BRIEF DESCRIPTION OF THE DRAWINGS

Exemplary embodiment(s) of the present invention will be described in detail based on the following figures, wherein:

FIG. 1A is a view illustrating a ship during a stop with a tilt-trim device mounted on the ship;

FIG. 1B is a view illustrating the ship during navigation with the tilt-trim device mounted on the ship;

FIG. 2 is a front view of the tilt-trim device shown in FIG. 1A;

FIG. 3 is a cross-sectional view of a main part of the tilt-trim device shown in FIG. 2 as viewed from a lateral side;

FIG. 4 is a circuit diagram of a drive mechanism shown in FIG. 3;

FIG. 5 is a diagram schematically showing the drive mechanism shown in FIG. 4;

FIG. 6 is a cross-sectional view showing first to fourth on-off valves shown in FIG. 5;

FIG. 7A is a view illustrating operations of the first to fourth on-off valves when a plunger is displaced;

FIG. 7B is a view illustrating the operations of the first to fourth on-off valves when each of first to fourth valve bodies is displaced;

FIG. 8 is a view illustrating an operation of the drive mechanism during high-speed up movement;

FIG. 9 is a view illustrating an operation of the drive mechanism during low-speed up movement;

FIG. 10 is a view illustrating an operation of the drive mechanism during high-speed down movement;

FIG. 11 is a view illustrating an operation of the drive mechanism during low-speed down movement;

FIG. 12 is a view illustrating an operation of the drive mechanism during down blow; and

FIG. 13 is a view illustrating an operation of the drive mechanism during up blow.

### DETAILED DESCRIPTION OF THE INVENTION

An example of the present disclosure will be described below with reference to the accompanying drawings. The example shown in the accompanying drawings is an example of the present disclosure, and the present invention is not limited to this embodiment.

### EXAMPLE

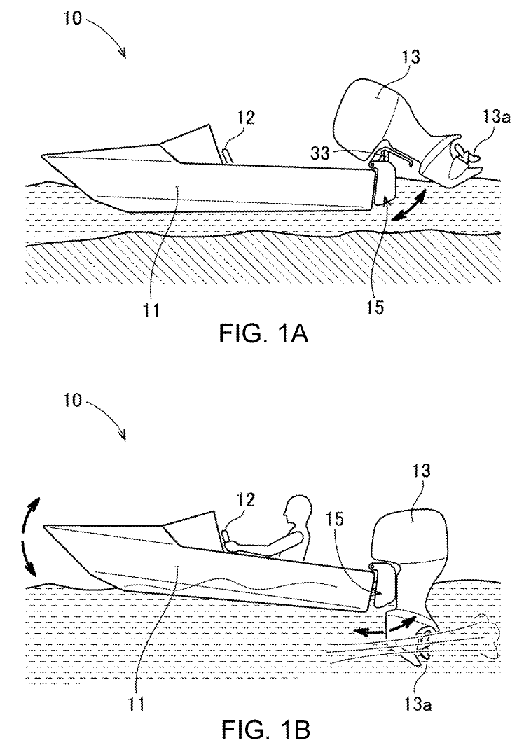

Reference is made to FIGS. 1A and 1B. FIG. 1A shows a ship 10 in a stopped state. FIG. 1B shows the ship 10 in a navigation state.

### Ship 10

The ship 10 includes, for example, a hull 11 on which an occupant Mn rides, a steering device 12 provided in a front portion of the hull 11 to operate a traveling direction of the hull 11, an outboard engine 13 serving as a power source and rotatable in a horizontal direction by operating the steering device 12, and a tilt-trim device 15 provided between the hull 11 and the outboard engine 13 to adjust an inclination angle of the hull 11 with respect to the outboard engine 13.

During an operation of the outboard engine 13, the occupant Mn operates the steering device 12 to adjust an orientation of the outboard engine 13, thereby operating the traveling direction of the hull 11. Further, the occupant Mn can adjust the inclination angle of the hull 11 with respect to the outboard engine 13 by operating the tilt-trim device 15 during both stop and navigation.

The ship 10 may include well-known components such as a switch for operating the tilt-trim device 15, a sensor that detects the operation on the switch, a speed sensor, a control unit that receives information detected by these sensors in a form of electrical signals, and the like.

The outboard engine 13 is swingable in the upper-lower direction. A propeller 13a is provided at a lower portion of the outboard engine 13. The outboard engine 13 is swung such that the propeller 13a is displaced above a water surface when the ship 10 is anchored. Meanwhile, when the ship 10 is traveling, the propeller 13a is located underwater. The hull 11 moves forward or backward.

Reference is made to FIG. 1A. For example, when the ship 10 leaves from a moored state, the occupant Mn operates the tilt-trim device 15 to swing the outboard engine 13 until the propeller 13a lands on water. Accordingly, the ship 10 can be navigated. Meanwhile, when mooring after navigation, the occupant Mn operates the tilt-trim device 15 to swing the outboard engine 13 such that the propeller 13a is positioned above the water surface. As an example, by positioning the outboard engine 13 above the water surface, it is possible to prevent shellfish or the like from adhering to the propeller 13a and protect the outboard engine 13. In the stopped state, it is desirable to swing the outboard engine 13 to a predetermined position in a short time.

Reference is made to FIG. 1B. The occupant Mn can adjust the inclination angle of the hull 11 by operating the tilt-trim device 15 even during navigation. When a bow is raised with respect to the water surface (the inclination angle of the hull 11 with respect to the outboard engine 13 increases), resistance received from the water decreases, and a speed tends to increase. Meanwhile, when the bow is lowered with respect to the water surface (the inclination angle of the hull 11 with respect to the outboard engine 13 decreases), the resistance received from the water increases, and stability increases. In the navigation state, it is desirable to finely adjust the inclination angle, and a swing speed of the outboard engine 13 may be slow.

### Tilt-trim Device 15

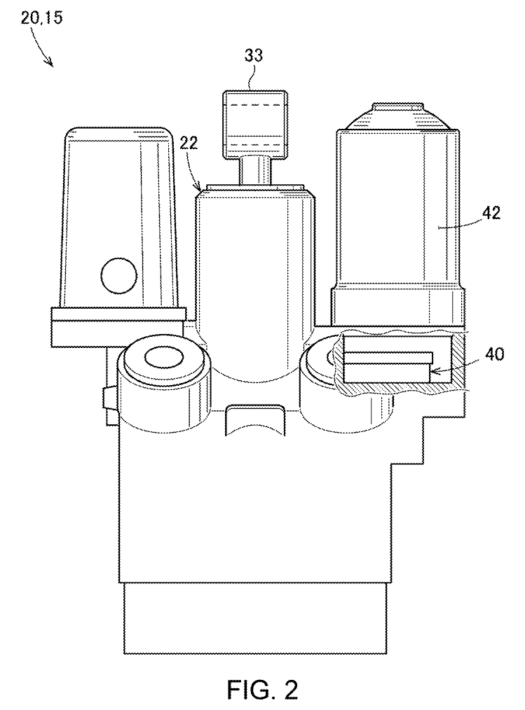

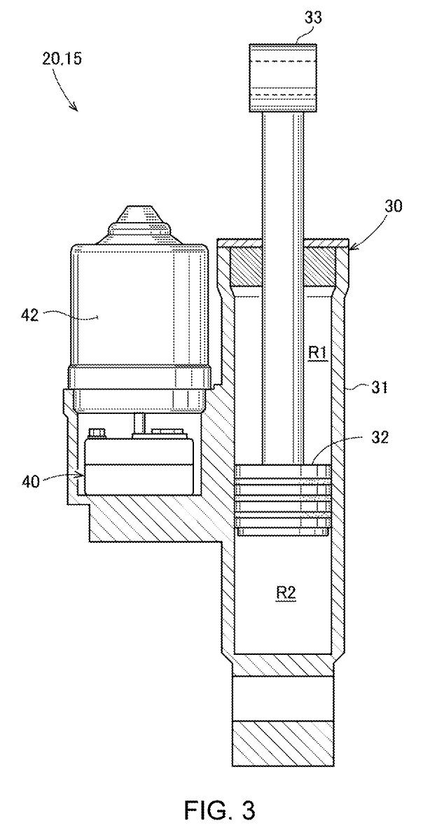

Reference is made to FIGS. 2 and 3. The tilt-trim device 15 is driven by a drive mechanism 20 as a drive source.

### Drive Mechanism 20

The drive mechanism 20 includes a tank 21 configured to store oil as a hydraulic fluid, a cylinder unit 30 in which a piston rod 33 advances and retreats due to the hydraulic fluid fed from the tank 21, and a pump unit 40 that feeds the hydraulic fluid from the tank 21 to the cylinder unit 30.

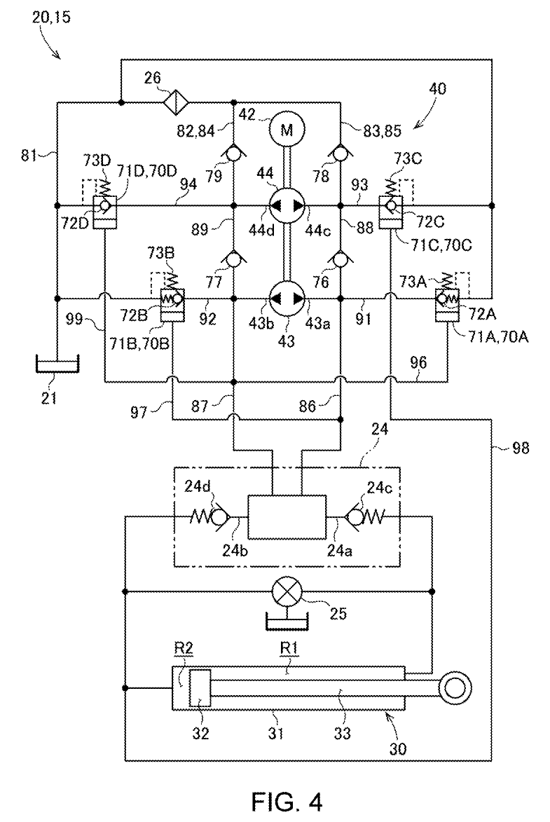

Reference is made to FIG. 4. The drive mechanism 20 further includes a switching valve 24 that is provided between the cylinder unit 30 and the pump unit 40 and switches a flow path of the discharged oil, a manual valve 25 that is provided between the cylinder unit 30 and the pump unit 40 and can manually switch between communication and non-communication of a bypass path connecting a first chamber R1 and a second chamber R2 inside the cylinder 31, and a filter 26 for removing foreign matter contained in the hydraulic fluid fed from the tank 21 to the pump unit 40.

### Cylinder Unit 30

The cylinder unit 30 includes the cylinder 31 having a substantially cylindrical shape, a piston 32 that partitions an inside of the cylinder 31 into two chambers including the first chamber R1 and the second chamber R2, and the piston rod 33 having one end fixed to the piston 32 and the other end protruding outside the cylinder 31.

The piston rod 33 retracts (descends) by feeding the hydraulic fluid to the first chamber R1. That is, by feeding the hydraulic fluid to the first chamber R1, a protruding amount of the piston rod 33 from the cylinder 31 decreases. The piston rod 33 advances (rises) by feeding the hydraulic fluid to the second chamber R2. That is, by feeding the hydraulic fluid to the second chamber R2, the protruding amount of the piston rod 33 from the cylinder 31 increases.

A tip end of the piston rod 33 is indirectly connected to the outboard engine 13 (see FIG. 1A). By advancing the piston rod 33, the outboard engine 13 rises. By retracting the piston rod 33, the outboard engine 13 decreases. A known configuration can be adopted as a configuration for connecting the outboard engine 13 and the piston rod 33.

### Pump Unit 40

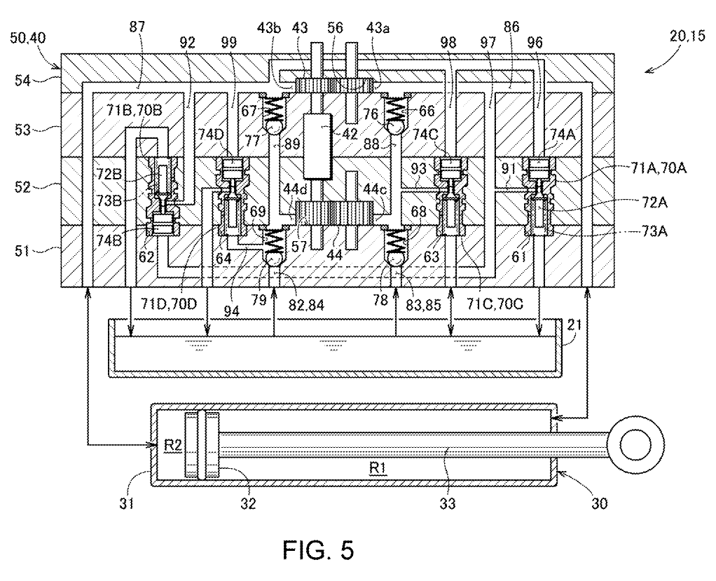

Reference is made to FIG. 5. The pump unit 40 includes, inside a pump housing 50 serving as a housing, a motor 42 that rotates in a first direction or a second direction opposite to the first direction by being energized, a first pump 43 and a second pump 44 that can feed the hydraulic fluid by the rotation of the motor 42, a first on-off valve 70A to a fourth on-off valve 70D that open the flow path when the pressure inside the cylinder 31 exceeds a predetermined pressure or when the pressure inside the flow path exceeds a predetermined pressure, and a first check valve 76 to a fourth check valve 79 that prevent the hydraulic fluid from flowing backward in the flow path.

### Pump Housing 50

The pump housing 50 is configured by, for example, combining four divided bodies, that is, a first divided body 51 to a fourth divided body 54. Inside the pump housing 50, the flow path is formed, and a first pump accommodating portion 56 and a second pump accommodating portion 57 in which the first pump 43 and the second pump 44 are accommodated, a first on-off valve accommodating portion 61 to a fourth on-off valve accommodating portion 64 in which the first on-off valve 70A to the fourth on-off valve 70D are accommodated, and a first check valve accommodating portion 66 to a fourth check valve accommodating portion 69 in which the first check valve 76 to the fourth check valve 79 are accommodated are formed. Details of the flow path will be described later.

The pump housing 50 may be constituted by two or three divided bodies, or may be constituted by five or more divided bodies. Hereinafter, the first divided body 51 to the fourth divided body 54 may be collectively referred to as "divided bodies 51 to 54".

### First Pump 43 and Second Pump 44

The first pump 43 and the second pump 44 are implemented by, for example, external gear pumps. A rotation shaft penetrating one of gears in the first pump 43 and the second pump 44 is connected to the motor 42. The other gear rotates as the one gear rotates. When the first pump 43 rotates in the first direction, the second pump 44 also rotates in the first direction. When the first pump 43 rotates in the second direction, the second pump 44 also rotates in the second direction.

A portion from which the hydraulic fluid is discharged when the first pump 43 operates in the first direction is referred to as a first discharge portion 43a. A portion from which the hydraulic fluid is discharged when the first pump 43 operates in the second direction is referred to as a second discharge portion 43b. That is, when rotating in the first direction, the first pump 43 sucks the hydraulic fluid from the second discharge portion 43b and discharges the hydraulic fluid from the first discharge portion 43a. When rotating in the second direction, the first pump 43 sucks the hydraulic fluid from the first discharge portion 43a and discharges the hydraulic fluid from the second discharge portion 43b.

A portion from which the hydraulic fluid is discharged when the second pump 44 operates in the first direction is referred to as a third discharge portion 44c. A portion from which the hydraulic fluid is discharged when the second pump 44 operates in the second direction is referred to as a fourth discharge portion 44d. That is, when rotating in the first direction, the second pump 44 sucks the hydraulic fluid from the fourth discharge portion 44d and discharges the hydraulic fluid from the third discharge portion 44c. When rotating in the second direction, the second pump 44 sucks the hydraulic fluid from the third discharge portion 44c and discharges the hydraulic fluid from the fourth discharge portion 44d.

The first pump 43 and the second pump 44 may be internal gear pumps. Alternatively, the first pump 43 may be implemented by an external gear pump, and the second pump 44 may be implemented by an internal gear pump. Alternatively, the first pump 43 may be implemented by an internal gear pump, and the second pump 44 may be implemented by an external gear pump.

### First On-Off Valve 70A

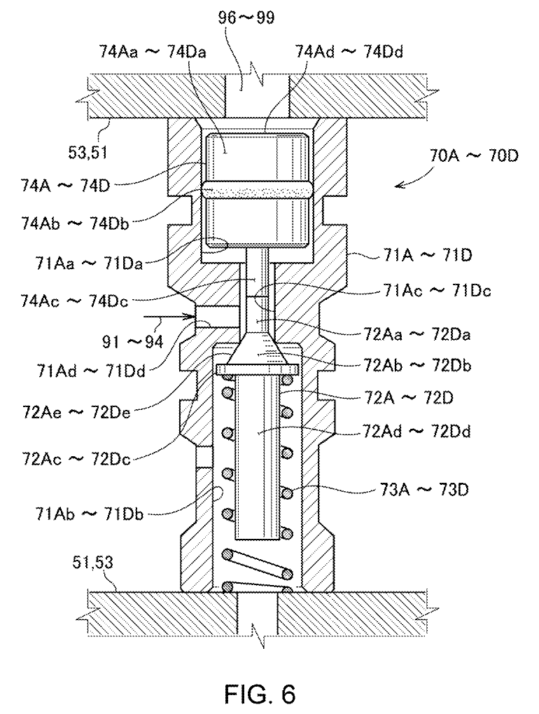

Reference is made to FIG. 6. The first on-off valve 70A to the fourth on-off valve 70D have the same configuration. First, the first on-off valve 70A will be described.

In the first on-off valve 70A, a first valve body 72A that receives a pressure of the hydraulic fluid, a first biasing member 73A that biases the first valve body 72A in a closing direction, and a first plunger 74A that can displace the first valve body 72A against a biasing force of the first biasing member 73A are accommodated inside a first valve box 71A accommodated in the first on-off valve accommodating portion 61 (see FIG. 5).

The first valve box 71A has a substantially tubular shape, one end thereof is in contact with the first divided body 51, and the other end thereof is in contact with the third divided body 53. Most of a side surface of the first valve box 71A is in contact with the second divided body 52. The first valve box 71A includes a first plunger accommodating portion 71Aa that accommodates the first plunger 74A and defines an advancing limit of the first plunger 74A, a first valve body accommodating portion 71Ab that accommodates the first valve body 72A and in which the first valve body 72A can come into contact with an end portion thereof, a first connection portion 71Ac that connects the first plunger accommodating portion 71Aa and the first valve body accommodating portion 71Ab and in which a tip end of the first valve body 72A and a tip end of the first plunger 74A face each other, and a first radial through-hole portion 71Ad that penetrates from an outer peripheral surface to the first connection portion 71Ac in a radial direction.

An inner diameter of the first plunger accommodating portion 71Aa is larger than an inner diameter of the first valve body accommodating portion 71Ab and an inner diameter of the first connection portion 71Ac. The inner diameter of the first valve body accommodating portion 71Ab is larger than the inner diameter of the first connection portion 71Ac. The advancing limits of the first plunger 74A and the first valve body 72A are defined by these portions. A retracting limit of the first plunger 74A is defined by the third divided body 53, and a retracting limit of the first valve body 72A is defined by the first divided body 51.

An end portion of the first plunger accommodating portion 71Aa, an end portion of the first valve body accommodating portion 71Ab, and the first radial through-hole portion 71Ad face a flow path. It will be described later which flow path each of these portions faces.

The first valve body 72A includes a pin-shaped first contact portion 72Aa whose tip end can come into contact with the first plunger 74A, a first valve main body 72Ab that has a truncated cone shape whose diameter increases from the first contact portion 72Aa and can come into contact with an end portion of the first valve body accommodating portion 71Ab, a first spring receiving portion 72Ac whose diameter further increases from the first valve main body 72Ab and that is in contact with the first biasing member 73A, and a first guide portion 72Ad that extends from the first spring receiving portion 72Ac along an inner periphery of the first biasing member 73A and prevents the first biasing member 73A from falling. A tapered outer peripheral surface of the first valve main body 72Ab is referred to as a first flow path-side pressure receiving surface 72Ae.

A compression coil spring is used as the first biasing member 73A. One end of the first biasing member 73A is in contact with the first spring receiving portion 72Ac, and the other end of the first biasing member 73A is in contact with the first divided body 51 to prevent detachment.

The first plunger 74A includes a columnar first plunger main body 74Aa, a first seal 74Ab that is provided on an outer periphery of the first plunger main body 74Aa and seals between the first plunger main body 74Aa and an inner peripheral surface of the first valve box 71A, and a pin-shaped first pressing portion 74Ac that protrudes from a center of the first plunger main body 74Aa toward the first contact portion 72Aa. A surface of the first plunger main body 74Aa that receives a pressure of the hydraulic fluid in a direction of advancing against the first biasing member 73A is referred to as a first plunger-side pressure receiving surface 74Ad. An area of the first plunger-side pressure receiving surface 74Ad is larger than an area of the first flow path-side pressure receiving surface 72Ae.

### Second On-Off Valve 70B

In the second on-off valve 70B, a second valve body 72B that receives a pressure of the hydraulic fluid, a second biasing member 73B that biases the second valve body 72B in a closing direction, and a second plunger 74B that can displace the second valve body 72B against a biasing force of the second biasing member 73B are accommodated inside a second valve box 71B accommodated in the second on-off valve accommodating portion 62.

The second valve box 71B has a substantially tubular shape, one end thereof is in contact with the first divided body 51, and the other end thereof is in contact with the third divided body 53. Most of a side surface of the second valve box 71B is in contact with the second divided body 52. The second valve box 71B includes a second plunger accommodating portion 71Ba that accommodates the second plunger 74B and defines an advancing limit of the second plunger 74B, a second valve body accommodating portion 71Bb that accommodates the second valve body 72B and in which the second valve body 72B can come into contact with an end portion thereof, a second connection portion 71Bc that connects the second plunger accommodating portion 71Ba and the second valve body accommodating portion 71Bb and in which a tip end of the second valve body 72B and a tip end of the second plunger 74B face each other, and a second radial through-hole portion 71Bd that penetrates from an outer peripheral surface to the second connection portion 71Bc in the radial direction.

An inner diameter of the second plunger accommodating portion 71Ba is larger than an inner diameter of the second valve body accommodating portion 71Bb and an inner diameter of the second connection portion 71Bc. The inner diameter of the second valve body accommodating portion 71Bb is larger than the inner diameter of the second connection portion 71Bc. The advancing limits of the second plunger 74B and the second valve body 72B are defined by these portions. A retracting limit of the second plunger 74B is defined by the first divided body 51, and a retracting limit of the second valve body 72B is defined by the third divided body 53.

An end portion of the second plunger accommodating portion 71Ba, an end portion of the second valve body accommodating portion 71Bb, and the second radial through-hole portion 71Bd face a flow path. It will be described later which flow path each of these portions faces.

The second valve body 72B includes a pin-shaped second contact portion 72Ba whose tip end can come into contact with the second plunger 74B, a second valve main body 72Bb that has a truncated cone shape whose diameter increases from the second contact portion 72Ba and can come into contact with an end portion of the second valve body accommodating portion 71Bb, a second spring receiving portion 72Bc whose diameter further increases from the second valve main body 72Bb and that is in contact with the second biasing member 73B, and a second guide portion 72Bd that extends from the second spring receiving portion 72Bc along an inner periphery of the second biasing member 73B and prevents the second biasing member 73B from falling. A tapered outer peripheral surface of the second valve main body 72Bb is referred to as a second flow path-side pressure receiving surface 72Be.

A compression coil spring is used as the second biasing member 73B. One end of the second biasing member 73B is in contact with the second spring receiving portion 72Bc, and the other end of the second biasing member 73B is in contact with the third divided body 53 to prevent detachment.

The second plunger 74B includes a columnar second plunger main body 74Ba, a second seal 74Bb that is provided on an outer periphery of the second plunger main body 74Ba and seals between the second plunger main body 74Ba and an inner peripheral surface of the second valve box 71B, and a pin-shaped second pressing portion 74Bc that protrudes from a center of the second plunger main body 74Ba toward the second contact portion 72Ba. A surface of the second plunger main body 74Ba that receives a pressure of the hydraulic fluid in a direction of advancing against the second biasing member 73B is referred to as a second plunger-side pressure receiving surface 74Bd. An area of the second plunger-side pressure receiving surface 74Bd is larger than an area of the second flow path-side pressure receiving surface 72Be.

### Third On-Off Valve 70C

In the third on-off valve 70C, a third valve body 72C that receives a pressure of the hydraulic fluid, a third biasing member 73C that biases the third valve body 72C in a closing direction, and a third plunger 74C that can displace the third valve body 72C against a biasing force of the third biasing member 73C are accommodated in a third valve box 71C accommodated in the third on-off valve accommodating portion 63.

The third valve box 71C has a substantially tubular shape, one end thereof is in contact with the first divided body 51, and the other end thereof is in contact with the third divided body 53. Most of a side surface of the third valve box 71C is in contact with the second divided body 52. The third valve box 71C includes a third plunger accommodating portion 71Ca that accommodates the third plunger 74C and defines an advancing limit of the third plunger 74C, a third valve body accommodating portion 71Cb that accommodates the third valve body 72C and in which the third valve body 72C can come into contact with an end portion thereof, a third connection portion 71Cc that connects the third plunger accommodating portion 71Ca and the third valve body accommodating portion 71Cb and in which a tip end of the third valve body 72C and a tip end of the third plunger 74C face each other, and a third radial through-hole portion 71Cd that penetrates from an outer peripheral surface to the third connection portion 71Cc in the radial direction.

An inner diameter of the third plunger accommodating portion 71Ca is larger than an inner diameter of the third valve body accommodating portion 71Cb and an inner diameter of the third connection portion 71Cc. An inner diameter of the third valve body accommodating portion 71Cb is larger than an inner diameter of the third connection portion 71Cc. The advancing limits of the third plunger 74C and the third valve body 72C are defined by these portions. A retracting limit of the third plunger 74C is defined by the third divided body 53, and a retracting limit of the third valve body 72C is defined by the first divided body 51.

An end portion of the third plunger accommodating portion 71Ca, an end portion of the third valve body accommodating portion 71Cb, and the third radial through-hole portion 71Cd face a flow path. It will be described later which flow path each of these portions faces.

The third valve body 72C includes a pin-shaped third contact portion 72Ca whose tip end can come into contact with the third plunger 74C, a third valve main body 72Cb that has a truncated cone shape whose diameter increases from the third contact portion 72Ca and can come into contact with an end portion of the third valve body accommodating portion 71Cb, a third spring receiving portion 72Cc whose diameter further increases from the third valve main body 72Cb and that is in contact with the third biasing member 73C, and a third guide portion 72Cd that extends from the third spring receiving portion 72Cc along an inner periphery of the third biasing member 73C and prevents the third biasing member 73C from falling. A tapered outer peripheral surface of the third valve main body 72Cb is referred to as a third flow path-side pressure receiving surface 72Ce.

A compression coil spring is used as the third biasing member 73C. One end of the third biasing member 73C is in contact with the third spring receiving portion 72Cc, and the other end of the third biasing member 73C is in contact with the first divided body 51 to prevent detachment.

The third plunger 74C includes a columnar third plunger main body 74Ca, a third seal 74Cb that is provided on an outer periphery of the third plunger main body 74Ca and seals between the third plunger main body 74Ca and an inner peripheral surface of the third valve box 71C, and a pin-shaped third pressing portion 74Cc that protrudes from a center of the third plunger main body 74Ca toward the third contact portion 72Ca. A surface of the third plunger main body 74Ca that receives a pressure of the hydraulic fluid in a direction of advancing against the third biasing member 73C is referred to as a third plunger-side pressure receiving surface 74Cd. An area of the third plunger-side pressure receiving surface 74Cd is larger than an area of the third flow path-side pressure receiving surface 72Ce.

### Fourth On-Off Valve 70D

In the fourth on-off valve 70D, a fourth valve body 72D that receives a pressure of the hydraulic fluid, a fourth biasing member 73D that biases the fourth valve body 72D in a closing direction, and a fourth plunger 74D that can displace the fourth valve body 72D against a biasing force of the fourth biasing member 73D are accommodated in a fourth valve box 71D accommodated in the fourth on-off valve accommodating portion 64.

The fourth valve box 71D has a substantially tubular shape, one end thereof is in contact with the first divided body 51, and the other end thereof is in contact with the third divided body 53. Most of a side surface of the fourth valve box 71D is in contact with the second divided body 52. The fourth valve box 71D includes a fourth plunger accommodating portion 71Da that accommodates the fourth plunger 74D and defines an advancing limit of the fourth plunger 74D, a fourth valve body accommodating portion 71Db that accommodates the fourth valve body 72D and in which the fourth valve body 72D can come into contact with an end portion thereof, a fourth connection portion 71Dc that connects the fourth plunger accommodating portion 71Da and the fourth valve body accommodating portion 71Db and in which a tip end of the fourth valve body 72D and a tip end of the fourth plunger 74 face each other, and a fourth radial through-hole portion 71Dd that penetrates from an outer peripheral surface to the fourth connection portion 71Dc in the radial direction.

An inner diameter of the fourth plunger accommodating portion 71Da is larger than an inner diameter of the fourth valve body accommodating portion 71Db and an inner diameter of the fourth connection portion 71Dc. The inner diameter of the fourth valve body accommodating portion 71Db is larger than the inner diameter of the fourth connection portion 71Dc. The advancing limits of the fourth plunger 74D and the fourth valve body 72D are defined by these portions. A retracting limit of the fourth plunger 74D is defined by the third divided body 53, and a retracting limit of the fourth valve body 72D is defined by the first divided body 51.

An end portion of the fourth plunger accommodating portion 71Da, an end portion of the fourth valve body accommodating portion 71Db, and the fourth radial through-hole portion 71Dd face a flow path. It will be described later which flow path each of these portions faces.

The fourth valve body 72D includes a pin-shaped fourth contact portion 72Da whose tip end can come into contact with the fourth plunger 74D, a fourth valve main body 72Db that has a truncated cone shape whose diameter increases from the fourth contact portion 72Da and can come into contact with an end portion of the fourth valve body accommodating portion 71Db, a fourth spring receiving portion 72Dc whose diameter further increases from the fourth valve main body 72Db and that is in contact with the fourth biasing member 73D, and a fourth guide portion 72Dd which extends from the fourth spring receiving portion 72Dc along an inner periphery of the fourth biasing member 73D and prevents the fourth biasing member 73D from falling. A tapered outer peripheral surface of the fourth valve main body 72Db is referred to as a fourth flow path-side pressure receiving surface 72De.

A compression coil spring is used as the fourth biasing member 73D. One end of the fourth biasing member 73D is in contact with the fourth spring receiving portion 72Dc, and the other end of the fourth biasing member 73D is in contact with the first divided body 51 to prevent detachment.

The fourth plunger 74D includes a columnar fourth plunger main body 74Da, a fourth seal 74Db that is provided on an outer periphery of the fourth plunger main body 74Da and seals between the fourth plunger main body 74Da and an inner peripheral surface of the fourth valve box 71D, and a pin-shaped fourth pressing portion 74Dc that protrudes from a center of the fourth plunger main body 74Da toward the fourth contact portion 72Da. A surface of the fourth plunger main body 74Da that receives a pressure of the hydraulic fluid in a direction of advancing against the fourth biasing member 73D is referred to as a fourth plunger-side pressure receiving surface 74Dd. An area of the fourth plunger-side pressure receiving surface 74Dd is larger than an area of the fourth flow path-side pressure receiving surface 72De.

### Switching Valve 24

Reference is made to FIG. 4. The switching valve 24 can adopt, for example, a known configuration including two valve boxes (not shown), operation valves (not shown) accommodated in the respective valve boxes, protruding portions 24a, 24b protruding from the operation valves, check valves 24c, 24d with which the protruding portions 24a, 24b are in contact, and communication paths (not shown) connecting the operation valves.

### Manual Valve 25

Reference is made to FIG. 1A. The manual valve 25 is a valve for manually returning the propeller 13a into the water to allow the hull 11 to be propelled, in a case where the pump unit 40 does not move for some reason when the propeller 13a is above the water surface. When the manual valve 25 is opened, the first chamber R1 and the second chamber R2 are connected by the bypass path.

### Flow Path

A flow path that connects the tank 21, the cylinder unit 30, and the pump unit 40 and through which the hydraulic fluid flows will be described.

The flow path includes a connection path 81 that connects the tank 21 to the pump unit 40 and is provided with the filter 26 in the middle, a first intake path 82 through which the hydraulic fluid is fed from the connection path 81 toward the second discharge portion 43b, a second intake path 83 through which the hydraulic fluid is fed from the connection path 81 toward the first discharge portion 43a, a third intake path 84 that is shared with the first intake path 82 and through which the hydraulic fluid is fed toward the fourth discharge portion 44d, and a fourth intake path 85 that is shared with the second intake path 83 and through which the hydraulic fluid is fed toward the third discharge portion 44c.

The first intake path 82 and the third intake path 84 are the same flow path, and the second intake path 83 and the fourth intake path 85 are the same flow path, but these flow paths may be configured separately. Hereinafter, the first intake path 82 to the fourth intake path 85 may be collectively referred to as "intake paths 82 to 85". It can be said that the intake paths 82 to 85 are flow paths for sucking the hydraulic fluid into the first pump 43 or the second pump 44.

The third check valve 78 is provided at an end portion downstream of the first intake path 82 and the third intake path 84. The fourth check valve 79 is provided at an end portion downstream of the second intake path 83 and the fourth intake path 85.

The flow path further includes a first flow path 86 connecting the first discharge portion 43a to the first chamber R1, a second flow path 87 connecting the second discharge portion 43b to the second chamber R2, a third flow path 88 connecting the third discharge portion 44c to the first chamber R1, and a fourth flow path 89 connecting the fourth discharge portion 44d to the second chamber R2.

The third flow path 88 merges with the first flow path 86 after passing through the first check valve 76. The fourth flow path 89 merges with the second flow path 87 after passing through the second check valve 77.

The flow path further includes a first branch path 91 branching from the first flow path 86 and reaching the connection path 81, a second branch path 92 branching from the second flow path 87 and reaching the connection path 81, a third branch path 93 branching from the third flow path 88 and reaching the connection path 81, and a fourth branch path 94 branching from the fourth flow path 89 and reaching the connection path 81.

Since the connection path 81 is connected to the intake paths 82 to 85, it can be said that each of the first branch path 91 to the fourth branch path 94 is connected to the intake paths 82 to 85.

The first branch path 91 to the fourth branch path 94 may be connected to the tank 21. At this time, some of the first branch path 91 to the fourth branch path 94 may be connected to the tank 21, and the rest may be connected to the intake paths 82 to 85 (connection path 81).

Further, the first branch path 91 and the third branch path 93 merge in the middle, and the second branch path 92 and the fourth branch path 94 are connected to the connection path 81. These paths may be merged in different combinations, or all of these paths may be directly connected to the connection path 81.

The first branch path 91 is provided with the first on-off valve 70A, and the hydraulic fluid flows from the first branch path 91 to the connection path 81 only in a predetermined case. The second branch path 92 is provided with the second on-off valve 70B, and the hydraulic fluid flows from the second branch path 92 to the connection path 81 only in a predetermined case. The third branch path 93 is provided with a third on-off valve 70C, and the hydraulic fluid flows from the third branch path 93 to the connection path 81 only in a predetermined case. The fourth branch path 94 is provided with the fourth on-off valve 70D, and the hydraulic fluid flows from the fourth branch path 94 to the connection path 81 only in a predetermined case.

The flow path further includes a first pressing path 96 branching from the second flow path 87 and reaching the first plunger accommodating portion 71Aa (see FIG. 6) of the first on-off valve 70A, a second pressing path 97 branching from the first flow path 86 and reaching the second plunger accommodating portion 71Ba (see FIG. 6) of the second on-off valve 70B, a third pressing path 98 branching from the second flow path 87 and reaching the third plunger accommodating portion 71Ca (see FIG. 6) of the third on-off valve 70C, and a fourth pressing path 99 branching from the second flow path 87 and reaching the fourth plunger accommodating portion 71Da (see FIG. 6) of the fourth on-off valve 70D.

### Operation

Next, operations of the drive mechanism 20 and the tilt-trim device 15 will be described.

### High-Speed Up Movement

Reference is made to FIG. 1A. For example, the outboard engine 13 may be swung to raise the propeller 13a above the water surface after the ship 10 stops. At this time, it is desirable that the outboard engine 13 can be swung in a short time.

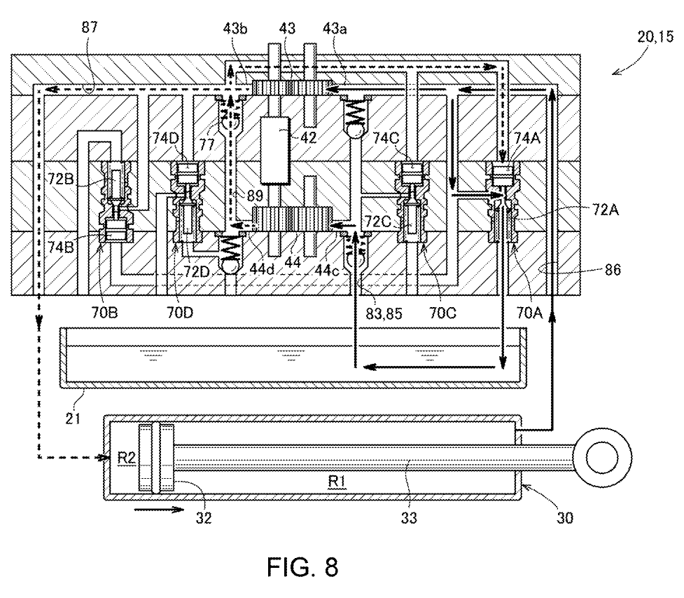

Reference is made to FIGS. 4 and 8. When the occupant operates the switch of the tilt-trim device 15, the drive mechanism 20 operates. Specifically, the motor 42 starts to rotate in the second direction, and the hydraulic fluid is sucked through the fourth intake path 85. The sucked hydraulic fluid reaches the second pump 44, is discharged from the fourth discharge portion 44d, passes through the fourth flow path 89, and pushes up the second check valve 77. The hydraulic fluid that has passed through the second check valve 77 merges with the second flow path 87, opens and passes through the switching valve 24, and flows into the second chamber R2. When the hydraulic fluid flows into the second chamber R2, the piston 32 and the piston rod 33 are pushed up.

When the hydraulic fluid passes through the second flow path 87 and the switching valve 24 is opened, the hydraulic fluid in the first chamber R1 flows through the first flow path 86 from the first chamber R1 toward the first pump 43. The hydraulic fluid is discharged from the second discharge portion 43b by the first pump 43 rotating in the second direction. The hydraulic fluid discharged from the second discharge portion 43b also passes through the second flow path 87 and is fed toward the second chamber R2.

That is, the hydraulic fluid is fed to the second chamber R2 from both pumps including the first pump 43 and the second pump 44. Since a flow rate of the hydraulic fluid is high, the piston rod 33 can be raised at a high speed.

When the piston rod 33 is raised, the hydraulic fluid is sucked up from the first chamber R1 by an output of the first pump 43. In the first flow path 86, in addition to the pressure of the hydraulic fluid generated by the working of the first pump 43, a force in a direction of pushing out the hydraulic fluid from the first chamber R1 may be applied via the piston 32 from the second chamber R2. When a moving speed of the piston 32 is higher with respect to the output of the first pump 43, the pressures in the first chamber R1 and the first flow path 86 may increase.

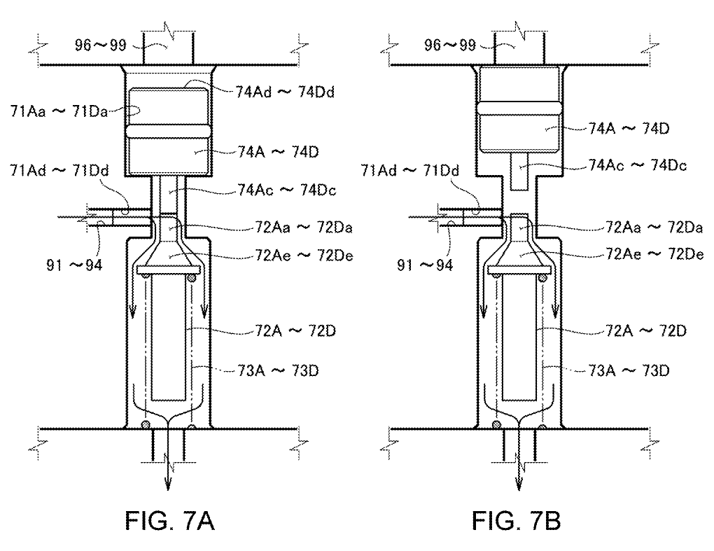

Reference is made to FIGS. 4 and 7B. When the pressure in the first flow path 86 is high, a pressure in the first branch path 91 branched from the first flow path 86 also increases. When the pressure in the first branch path 91 exceeds a predetermined pressure, the first valve body 72A is pushed down to open the first branch path 91. When the first branch path 91 is opened, the hydraulic fluid is returned to the connection path 81 (or the tank 21). The hydraulic fluid returned to the connection path 81 is sucked up through the intake paths 82 to 85. Accordingly, a surplus hydraulic fluid can be released upstream. When the pressure in the first branch path 91 is lower than a predetermined pressure, the first valve body 72A closes the first branch path 91 by the biasing force of the first biasing member 73A.

In FIG. 7B, the first plunger 74A and the first valve body 72A are shown in a separated state for convenience of description. Actually, since the pressure of the hydraulic fluid is also applied to the first plunger 74A from the first pressing path 96, the first plunger 74A is displaced following the pushing down of the first valve body 72A.

### Low-Speed Up Movement

Reference is made to FIG. 1B. For example, the bow may be raised in order to make it easier to increase a speed during navigation of the ship 10. At this time, the bow is raised by advancing the piston rod 33 (see FIG. 4). At this time, it is desirable to slowly swing the outboard engine 13 such that fine adjustment can be performed.

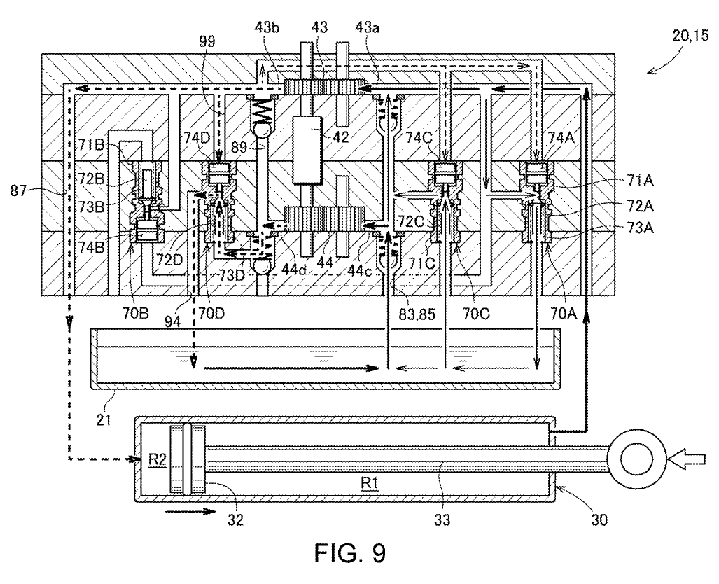

Reference is made to FIG. 9. During navigation, a load (see a white arrow) is applied to the piston rod 33 in a retracting direction due to an influence of resistance from water received by the outboard engine 13 (see FIG. 1B). Therefore, pressures in the second chamber R2 and the second flow path 87 increase.

Reference is also made to FIG. 7A. Since the pressures in the second chamber R2 and the second flow path 87 are high, a pressure in the fourth pressing path 99 branched from the second flow path 87 also increases. When the pressure in the fourth pressing path 99 is higher than a predetermined pressure, the fourth plunger 74D pushes down the fourth valve body 72D against the biasing force of the fourth biasing member 73D. When the fourth valve body 72D is pushed down, the fourth branch path 94 branched from the fourth flow path 89 is opened.

Reference is made to FIGS. 4 and 9. When the second pump 44 operates in the second direction in a state where the fourth branch path 94 is opened, the hydraulic fluid sucked up from the second intake path 83 is discharged from the fourth discharge portion 44d, passes through the fourth branch path 94, and is returned to the connection path 81 (or the tank 21). The hydraulic fluid returned to the connection path 81 is sucked up from any of the intake paths 82 to 85.

Meanwhile, when the first pump 43 operates in the second direction, the hydraulic fluid is sucked up from the first chamber R1, discharged from the second discharge portion 43b, and fed toward the second chamber R2.

That is, when the tilt-trim device 15 is operated during navigation of the ship, the hydraulic fluid is fed from only the first pump 43 to the second chamber R2, and the hydraulic fluid is not fed from the second pump 44 to the second chamber R2. Therefore, the outboard engine 13 (see FIG. 1B) can be swung at a lower speed than during the high-speed up movement. By swinging at a low speed, a displacement amount can be finely adjusted.

### High-Speed Down Movement

Reference is made to FIG. 1A. For example, when the ship 10 is to be navigated, the outboard engine 13 may be swung to lower the propeller 13a in a stopped state into the water. At this time, it is desirable that the outboard engine 13 can be swung in a short time.

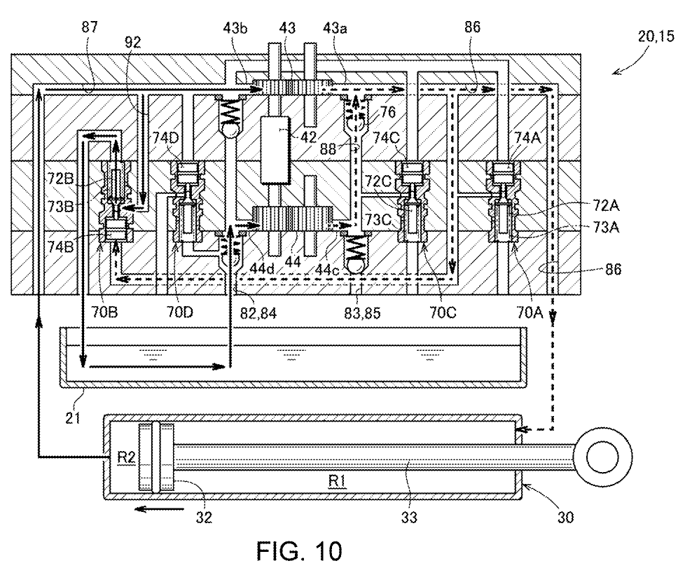

Reference is made to FIGS. 4 and 10. When the occupant operates the switch of the tilt-trim device 15, the drive mechanism 20 operates. Specifically, the motor 42 starts to rotate in the first direction, and the hydraulic fluid is sucked through the third intake path 84. The sucked hydraulic fluid reaches the second pump 44, is discharged from the third discharge portion 44c, passes through the third flow path 88, and pushes up the first check valve 76. The hydraulic fluid that has passed through the first check valve 76 merges with the first flow path 86, opens and passes through the switching valve 24, and flows into the first chamber R1. When the hydraulic fluid flows into the first chamber R1, the piston 32 and the piston rod 33 are pushed down.

When the hydraulic fluid passes through the first flow path 86, and the switching valve 24 is opened, the hydraulic fluid in the second chamber R2 flows through the second flow path 87 from the second chamber R2 toward the first pump 43. The hydraulic fluid is discharged from the first discharge portion 43a by the first pump 43 rotating in the first direction. The hydraulic fluid discharged from the first discharge portion 43a also passes through the first flow path 86 and is fed toward the first chamber R1.

That is, the hydraulic fluid is fed to the first chamber R1 from both the first pump 43 and the second pump 44. Since a flow rate of the hydraulic fluid is high, the piston rod 33 can be lowered at a high speed.

When the piston rod 33 is lowered, the hydraulic fluid is sucked up from the second chamber R2 by the output of the first pump 43. In the second flow path 87, in addition to the pressure of the hydraulic fluid generated by the working of the first pump 43, a force in a direction of pushing out the hydraulic fluid from the second chamber R2 may be applied via the piston 32 from the first chamber R1. When the moving speed of the piston 32 is higher with respect to the output of the first pump 43, the pressures in the second chamber R2 and the second flow path 87 may increase.

Reference is made to FIGS. 4 and 7B. When the pressure in the second flow path 87 is high, a pressure in the second branch path 92 branched from the second flow path 87 also increases. When the pressure in the second branch path 92 exceeds a predetermined pressure, the second valve body 72B is displaced to open the second branch path 92. When the second branch path 92 is opened, the hydraulic fluid is returned to the connection path 81 (or the tank 21). The hydraulic fluid returned to the connection path 81 is sucked up through any of the intake paths 82 to 85. Accordingly, a surplus hydraulic fluid can be released upstream. When the pressure in the second branch path 92 is lower than a predetermined pressure, the second valve body 72B closes the second branch path 92 by the biasing force of the second biasing member 73B.

### Low-Speed Down Movement

Reference is made to FIG. 1B. For example, the bow may be lowered in order to improve operability during navigation of the ship 10. At this time, the bow is lowered by retracting the piston rod 33 (see FIG. 4). At this time, it is desirable to slowly swing the outboard engine 13 such that fine adjustment can be performed.

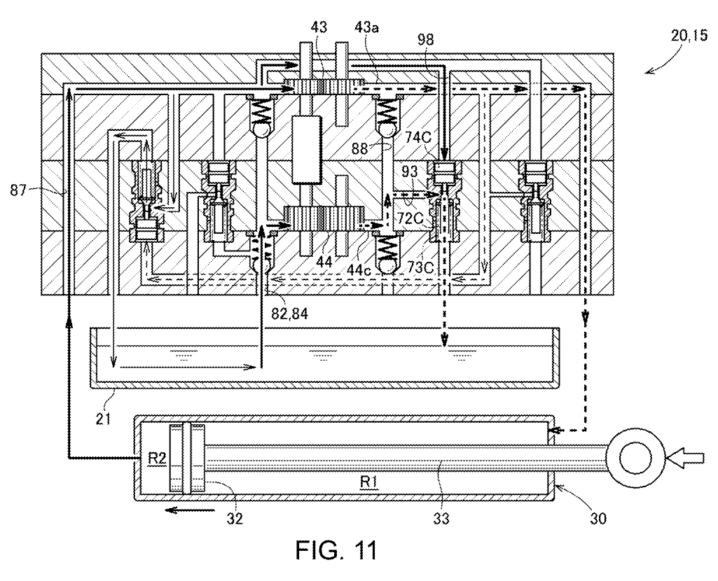

Reference is made to FIG. 11. During navigation, a load (see a white arrow) is applied to the piston rod 33 in a retracting direction due to the influence of resistance from the water received by the outboard engine 13 (see FIG. 1B). Therefore, the pressures in the second chamber R2 and the second flow path 87 increase.

Reference is also made to FIG. 7A. Since the pressures in the second chamber R2 and the second flow path 87 are high, a pressure in the third pressing path 98 branched from the second flow path 87 also increases. When the pressure in the third pressing path 98 is higher than a predetermined pressure, the third plunger 74C pushes down the third valve body 72C against the biasing force of the third biasing member 73C. When the third valve body 72C is pushed down, the third branch path 93 branched from the third flow path 88 is opened.

Reference is made to FIGS. 4 and 11. When the second pump 44 operates in the first direction in a state where the third branch path 93 is opened, the hydraulic fluid sucked up from the third intake path 84 is discharged from the third discharge portion 44c, passes through the third branch path 93, and is returned to the connection path 81 (or the tank 21). The hydraulic fluid returned to the connection path 81 is sucked up through any of the intake paths 82 to 85.

Meanwhile, when the first pump 43 operates in the first direction, the hydraulic fluid is sucked up from the second chamber R2, discharged from the first discharge portion 43a, and fed toward the first chamber R1.

That is, when the tilt-trim device 15 is operated during navigation of the ship, the hydraulic fluid is fed from only the first pump 43 to the first chamber R1, and the hydraulic fluid is not fed from the second pump 44 to the first chamber R1. Therefore, the outboard engine 13 (see FIG. 1B) can be swung at a lower speed than during the high-speed up movement. By swinging at a low speed, the displacement amount can be finely adjusted.

### Down Blow

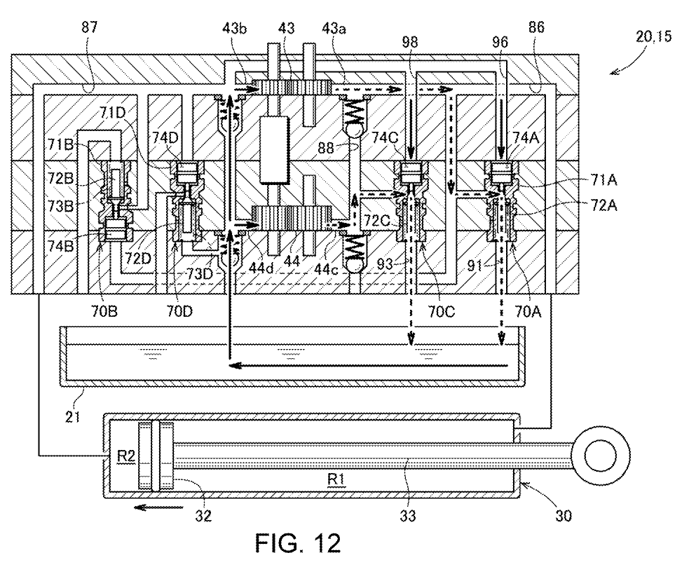

Reference is made to FIG. 12. When the piston rod 33 approaches the retracting limit during the down movement at both a high speed and a low speed, the pressure in the second chamber R2 rapidly increases.

Reference is also made to FIG. 7A. When the pressure in the second chamber R2 exceeds a predetermined pressure, the pressures in the first pressing path 96 and the third pressing path 98 branched from the second flow path 87 also increase, the first plunger 74A and the third plunger 74C are pushed down, and the first branch path 91 and the third branch path 93 are opened. Then, since the pressure in the second chamber R2 is high, the pressure in the first chamber R1 also increases. The hydraulic fluid does not flow into the first chamber R1 having a high pressure, but flows from the first branch path 91 and the third branch path 93 into the connection path 81 (see FIG. 4) or the tank 21. Accordingly, the retraction of the piston rod 33 can be prevented.

Reference is made to FIGS. 7B and 12. In a case where the pressure in the first chamber R1 is high and a pressure downstream the first on-off valve 70A or downstream the third on-off valve 70C is low, when a difference between the pressures exceeds a certain value, the hydraulic fluid pushes down the first valve body 72A or the third valve body 72C rather than flowing into the first chamber R1. The hydraulic fluid does not flow into the first chamber R1 having a high pressure, but flows from the first branch path 91 and the third branch path 93 into the connection path 81 (see FIG. 4) or the tank 21. Accordingly, the retraction of the piston rod 33 can be prevented.

### Up Blow

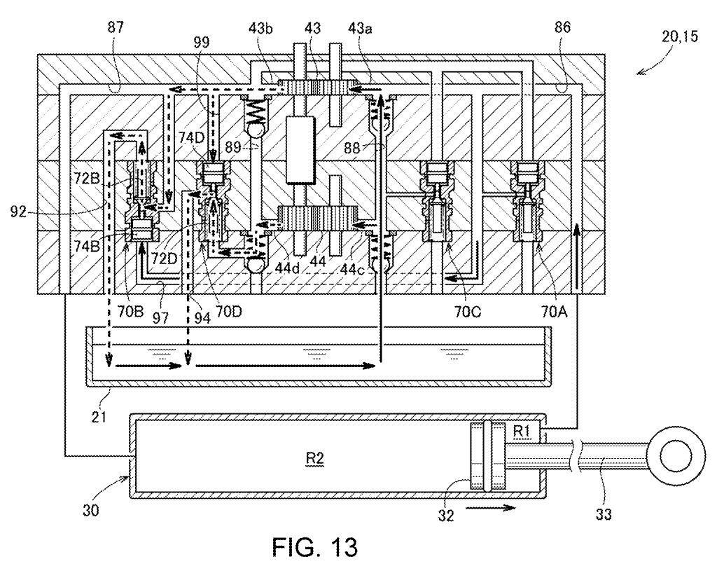

Reference is made to FIG. 13. When the piston rod 33 approaches the advancing limit during the up movement at both a high speed and a low speed, the pressure in the first chamber R1 rapidly increases.

Reference is also made to FIG. 7A. When the pressure in the first chamber R1 exceeds a predetermined pressure, the pressure in the second pressing path 97 branched from the first flow path 86 also increases, the second plunger 74B is displaced, and the second branch path 92 is opened. Then, since the pressure in the first chamber R1 is high, the pressure in the second chamber R2 also increases. The hydraulic fluid does not flow to the second chamber R2 having a high pressure, but flows from the second branch path 92 to the connection path 81 (see FIG. 4) or the tank 21.

When the pressure in the second chamber R2 exceeds a predetermined pressure, the pressure in the fourth pressing path 99 branched from the second flow path 87 also increases. Accordingly, the fourth plunger 74D is pushed down, and the fourth branch path 94 is opened. The hydraulic fluid does not flow to the second chamber R2 having a high pressure, but flows from the fourth branch path 94 to the connection path 81 (see FIG. 4) or the tank 21. Accordingly, the advancing of the piston rod 33 can be prevented.

Reference is made to FIGS. 7B and 13. Further, in a case where the pressure in the first chamber R1 is high and a pressure downstream the second on-off valve 70B or downstream the fourth on-off valve 70D is low, when the difference between the pressures exceeds a certain value, the hydraulic fluid displaces the second valve body 72B or the fourth valve body 72D rather than flowing into the second chamber R2. The hydraulic fluid does not flow to the second chamber R2 having a high pressure, but flows from the second branch path 92 and the fourth branch path 94 to the connection path 81 (see FIG. 4) or the tank 21. Accordingly, the advancing of the piston rod 33 can be prevented.

The drive mechanism 20 and the tilt-trim device 15 described above are summarized below.

Reference is made to FIG. 4. In a first aspect, the drive mechanism 20 includes the tank 21 in which the hydraulic fluid is stored, the cylinder unit 30 in which the piston rod 33 advances and retreats due to the hydraulic fluid fed from the tank 21, and the pump unit 40 that feeds the hydraulic fluid from the tank 21 to the cylinder unit 30. The cylinder unit 30 includes the cylinder 31 having the substantially cylindrical shape, the piston 32 that partitions the inside of the cylinder 31 into two chambers including the first chamber R1 and the second chamber R2, and the piston rod 33 having one end fixed to the piston 32 and the other end protruding outside the cylinder 31. The protruding amount of the piston rod 33 from the cylinder 31 decreases by feeding the hydraulic fluid to the first chamber R1, and the protruding amount of the piston rod 33 from the cylinder 31 increases by feeding the hydraulic fluid to the second chamber R2. The pump unit 40 includes: the first pump 43 that is capable of discharging the hydraulic fluid from the first discharge portion 43a by rotating in the first direction and discharging the hydraulic fluid from the second discharge portion 43b by rotating in the second direction opposite to the first direction; the second pump 44 that is a pump different from the first pump 43, operates in conjunction with the operation of the first pump 43, and is capable of discharging the hydraulic fluid from the third discharge portion 44c by rotating in the first direction and discharging the hydraulic fluid from the fourth discharge portion 44d by rotating in the second direction; the intake paths 82 to 85 for sucking the hydraulic fluid to feed into the first pump 43 or the second pump 44; the first flow path 86 that connects the first chamber R1 to the first discharge portion 43a and is a flow path for the hydraulic fluid to flow therethrough; a second flow path 87 that connects the second chamber R2 to the second discharge portion 43b and is a flow path for the hydraulic fluid to flow therethrough; the third flow path 88 that connects the first chamber R1 to the third discharge portion 44c and is a flow path for the hydraulic fluid to flow therethrough; the fourth flow path 89 that connects the second chamber R2 to the fourth discharge portion 44d and is a flow path for the hydraulic fluid to flow therethrough; the second branch path 92 that branches from the second flow path 87 to reach at least one of the tank 21 or the intake paths 82 to 85; and the second on-off valve 70B that is provided in the second branch path 92 and opens the second branch path 92 in a case where the pressure in the first chamber R1 is higher than a predetermined pressure when the first pump 43 rotates in the second direction or in a case where the pressure in the second flow path 87 is higher than a predetermined pressure when the first pump 43 rotates in the first direction.

The second on-off valve 70B opens the second branch path 92 in the case where the pressure in the first chamber R1 is higher than the predetermined pressure when the first pump 43 rotates in the second direction, or in the case where the pressure in the second flow path 87 is higher than the predetermined pressure when the first pump 43 rotates in the first direction. That is, the second branch path 92 is opened during up blow (see FIG. 13) and during high-speed down movement (see FIG. 10). In both cases where the rotation direction of the first pump 43 is different, the second branch path 92 can be opened by one valve. The number of valves can be reduced as compared with a case where separate valves are used for the up blow and the high-speed down movement. The drive mechanism 20 including a small number of components can be provided.

In a second aspect, in the drive mechanism 20 of the first aspect, the pump unit 40 further includes the first branch path 91 that branches from the first flow path 86 to reach at least one of the tank 21 or the intake paths 82 to 85, and the first on-off valve 70A that is provided in the first branch path 91 and opens the first branch path 91 in a case where the pressure in the second chamber R2 is higher than a predetermined pressure when the first pump 43 rotates in the first direction or in a case where the pressure in the first flow path 86 is higher than a predetermined pressure when the first pump 43 rotates in the second direction.

The first on-off valve 70A opens the first branch path 91 in the case where the pressure in the second chamber R2 is higher than the predetermined pressure when the first pump 43 rotates in the first direction or in the case where the pressure in the first flow path 86 is higher than the predetermined pressure when the first pump 43 rotates in the second direction. That is, the first branch path 91 is opened during down blow (see FIG. 12) and during high-speed up movement (see FIG. 8). In both cases where the rotation direction of the first pump 43 is different, the first branch path 91 can be opened by one valve. The number of valves can be reduced as compared with a case where separate valves are used for the down blow and the high-speed up movement. The drive mechanism 20 including an even small number of components can be provided.

In a third aspect, in the drive mechanism 20 of the first or second aspect, the pump unit 40 further includes the third branch path 93 that branches from the third flow path 88 to reach at least one of the tank 21 or the intake paths 82 to 85, and the third on-off valve 70C that is provided in the third branch path 93 and opens the third branch path 93 in a case where the pressure in the second chamber R2 is higher than a predetermined pressure when the second pump 44 rotates in the first direction and in a case where the pressure in the third flow path 88 is higher than a predetermined pressure when the second pump 44 rotates in the first direction.

Reference is also made to FIG. 1B. For example, when the drive mechanism 20 is mounted on the ship 10, a large pressure is applied to the second chamber R2 via the outboard engine 13 during navigation of the ship 10. At this time, the third on-off valve 70C opens the third branch path 93. The hydraulic fluid discharged from the third discharge portion 44c is returned to the tank 21 or the intake paths 82 to 85, and does not flow into the first chamber R1 (see FIG. 11). Thus, the outboard engine 13 can be lowered at a low speed (low-speed down movement). When reducing the inclination angle of the hull 11 with respect to the outboard engine 13, fine adjustment can be performed. Further, during stop of the ship (see FIG. 1A), when the pressure in the third flow path 88 is higher than a predetermined pressure, the third branch path 93 can also be opened to release the hydraulic fluid to the tank 21 or the intake paths 82 to 85.

Reference is made only to FIG. 4. In a fourth aspect, in the drive mechanism 20 of any one of the first to third aspects, the pump unit 40 further includes the fourth branch path 94 that branches from the fourth flow path 89 to reach at least one of the tank 21 or the intake paths 82 to 85, and the fourth on-off valve 70D that is provided in the fourth branch path 94 and opens the fourth branch path 94 in a case where the pressure in the second chamber R2 is higher than a predetermined pressure when the second pump 44 rotates in the second direction and in a case where the pressure in the fourth flow path 89 is higher than a predetermined pressure when the second pump 44 rotates in the second direction.

Reference is also made to FIG. 1B. For example, when the drive mechanism 20 is mounted on the ship 10, a large pressure is applied to the second chamber R2 via the outboard engine 13 during navigation of the ship 10. At this time, the fourth on-off valve 70D opens the fourth branch path 94. The hydraulic fluid discharged from the fourth discharge portion 44d is returned to the tank 21 or the intake paths 82 to 85, and does not flow into the second chamber R2 (see FIG. 9). Thus, the outboard engine 13 can be raised at a low speed (low-speed up movement). When increasing the inclination angle of the hull 11 with respect to the outboard engine 13, fine adjustment can be performed. Further, during stop of the ship (see FIG. 1A), when the pressure in the fourth flow path 89 is higher than a predetermined pressure, the fourth branch path 94 can also be opened to release the hydraulic fluid to the tank 21 or the intake paths 82 to 85.

Reference is made to FIGS. 4 and 6. In a fifth aspect, in the drive mechanism 20 of any one of the first to fourth aspects, the second on-off valve 70B includes the second valve body 72B having the second flow path-side pressure receiving surface 72Be that receives the pressure of the hydraulic fluid from the second flow path 87 and capable of opening and closing the second branch path 92, the second biasing member 73B that biases the second valve body 72B in the closing direction, and the second plunger 74B having the second plunger-side pressure receiving surface 74Bd that receives the pressure of the hydraulic fluid from the first flow path 86 and capable of displacing the second valve body 72B against the biasing force of the second biasing member 73B. A valve having a simple configuration and serving for both up blow and high-speed down movement can be provided.

In a sixth aspect, in the drive mechanism 20 of the fifth aspect, the area of the second plunger-side pressure receiving surface 74Bd is larger than the area of the second flow path-side pressure receiving surface 72Be. By making a difference in the pressure receiving area, it is possible to make a difference between a predetermined pressure at which the second valve body 72B operates and a predetermined pressure at which the second plunger 74B operates.

Reference is made to FIG. 5. In a seventh aspect, in the drive mechanism 20 of any one of the first to sixth aspects, the pump unit 40 further includes the pump housing 50 which is a housing constituted by the plurality of divided bodies 51 to 54. The pump housing 50 includes the second on-off valve accommodating portion 62 that accommodates the second on-off valve 70B. The second on-off valve 70B can be easily provided, and assembly can be improved.

Reference is made to FIG. 4. In an eighth aspect, in the drive mechanism 20 of any one of the first to seventh aspects, the third flow path 88 merges with the first flow path 86. The drive mechanism 20 can be made compact as compared with a case where the respective flow paths are formed separately.

In a ninth aspect, in the drive mechanism 20 of any one of the first to eighth aspects, the fourth flow path 89 merges with the second flow path 87. The drive mechanism 20 can be made compact as compared with a case where the respective flow paths are formed separately.

Reference is made to FIG. 5. In a tenth aspect, in the drive mechanism 20 of any one of the first to ninth aspects, the second pump 44 is disposed at a portion closer to the tank 21 than the first pump 43. An entire length of the flow path that circulates through the second pump 44 can be shortened, and an energy loss due to pipeline resistance can be prevented. Accordingly, the hydraulic fluid can be efficiently circulated.

Reference is made to FIGS. 1A, 1B and 3. In an eleventh aspect, the tilt-trim device 15 includes the drive mechanism 20 of any one of the first to tenth aspects, is provided on the hull 11, and adjusts the inclination angle of the hull 11 with respect to the outboard engine 13. The inclination angle of the hull 11 with respect to the outboard engine 13 is increased by supplying the hydraulic fluid to the second chamber R2, and the inclination angle of the hull 11 with respect to the outboard engine 13 is decreased by supplying the hydraulic fluid to the first chamber R1. The tilt-trim device 15 equipped with the drive mechanism 20 including a small number of components can be provided.

Although an example in which the drive mechanism according to the present disclosure is mounted on the tilt-trim device used in the ship has been described as an example, the present invention is applicable to other applications and is not limited to these types. That is, the present invention is not limited to the example as long as the functions and effects of the present invention are achieved.

### INDUSTRIAL APPLICABILITY

The drive mechanism of the present disclosure is suitable for being mounted on the tilt-trim device of a ship.

What is claimed is:

1. A drive mechanism comprising:
a tank configured to store a hydraulic fluid;
a cylinder unit in which a piston rod advances and retreats due to the hydraulic fluid fed from the tank; and
a pump unit configured to feed the hydraulic fluid from the tank to the cylinder unit, wherein
the cylinder unit includes:
a cylinder having a cylindrical shape;
a piston that partitions an inside of the cylinder into two chambers including a first chamber and a second chamber; and
the piston rod having one end fixed to the piston and another end protruding outside the cylinder,
a protruding amount of the piston rod from the cylinder decreases by feeding the hydraulic fluid to the first chamber, and the protruding amount of the piston rod from the cylinder increases by feeding the hydraulic fluid to the second chamber, and
the pump unit includes:
a first pump configured to discharge the hydraulic fluid from a first discharge portion by rotating in a first direction, and configured to discharge the hydraulic fluid from a second discharge portion by rotating in a second direction opposite to the first direction;
a second pump different from the first pump, operating in conjunction with an operation of the first pump, configured to discharge the hydraulic fluid from a third discharge portion by rotating in the first direction, and configured to discharge the hydraulic fluid from a fourth discharge portion by rotating in the second direction;
an intake path through which the hydraulic fluid is sucked to feed into the first pump or the second pump;
a first flow path connecting the first chamber to the first discharge portion, and through which the hydraulic fluid flows;
a second flow path connecting the second chamber to the second discharge portion, and through which the hydraulic fluid flows;
a third flow path connecting the first chamber to the third discharge portion, and through which the hydraulic fluid flows;
a fourth flow path connecting the second chamber to the fourth discharge portion, and through which the hydraulic fluid flows;
a second branch path branching from the second flow path to reach at least one of the tank or the intake path; and
a second on-off valve provided in the second branch path, and configured to open the second branch path in a case where a pressure in the first chamber is higher than a predetermined pressure when the first pump rotates in the second direction or in a case where a pressure in the second flow path is higher than a predetermined pressure when the first pump rotates in the first direction.

2. The drive mechanism according to claim 1, wherein
the pump unit further includes:
a first branch path branching from the first flow path to reach at least one of the tank or the intake path; and
a first on-off valve provided in the first branch path, and configured to open the first branch path in a case where a pressure in the second chamber is higher than a predetermined pressure when the first pump rotates in the first direction or in a case where a pressure in the first flow path is higher than a predetermined pressure when the first pump rotates in the second direction.

3. The drive mechanism according to claim 2, wherein
the pump unit further includes:
a third branch path branching from the third flow path to reach at least one of the tank or the intake path; and
a third on-off valve provided in the third branch path, and configured to open the third branch path in a case where the pressure in the second chamber is higher than a predetermined pressure when the second pump rotates in the first direction or in a case where a pressure in the third flow path is higher than a predetermined pressure when the second pump rotates in the first direction.

4. The drive mechanism according to claim 3, wherein
the pump unit further includes:
a fourth branch path branching from the fourth flow path to reach at least one of the tank or the intake path; and
a fourth on-off valve provided in the fourth branch path, and configured to open the fourth branch path in a case where the pressure in the second chamber is higher than a predetermined pressure when the second pump rotates in the second direction or in a case where a pressure in the fourth flow path is higher than a predetermined pressure when the second pump rotates in the second direction.

5. The drive mechanism according to claim 1, wherein
the second on-off valve includes:
a valve body having a flow path-side pressure receiving surface that receives a pressure of the hydraulic fluid from the second flow path, and configured to open and close the second branch path;
a biasing member biasing the valve body in a closing direction; and
a plunger having a plunger-side pressure receiving surface that receives a pressure of the hydraulic fluid from the first flow path, and configured to displace the valve body against a biasing force of the biasing member.

6. The drive mechanism according to claim 5, wherein
an area of the plunger-side pressure receiving surface is larger than an area of the flow path-side pressure receiving surface.

7. The drive mechanism according to claim 1, wherein
the pump unit further includes:
a pump housing constituted by a plurality of divided bodies, and
the pump housing includes an accommodating portion that accommodates the second on-off valve.

8. The drive mechanism according to claim 1, wherein
the third flow path merges with the first flow path.

9. The drive mechanism according to claim 1, wherein
the fourth flow path merges with the second flow path.

10. The drive mechanism according to claim 1, wherein
the second pump is disposed at a portion closer to the tank than the first pump.

11. A tilt-trim device provided on a hull to adjust an inclination angle of the hull with respect to an outboard engine, the tilt-trim device comprising:
the drive mechanism according to claim 1, wherein
the inclination angle of the hull with respect to the outboard engine is increased by supplying the hydraulic fluid to the second chamber, and
the inclination angle of the hull with respect to the outboard engine is decreased by supplying the hydraulic fluid to the first chamber.
